(19) United States
(12) Patent Application Publication
(10) Pub. No.: US 2019/0226322 A1
(43) Pub. Date: Jul. 25, 2019

(54) HIGH-RESOLUTION REMOTE-FIELD EDDY CURRENT CHARACTERIZATION OF PIPES

(71) Applicant: Halliburton Energy Services, Inc., Houston, TX (US)

(72) Inventors: Reza Khalaj Amineh, Houston, TX (US); Burkay Donderici, Pittsford, NY (US); Luis Emilio San Martin, Houston, TX (US)

(21) Appl. No.: 16/316,900

(22) PCT Filed: Aug. 12, 2016
(86) PCT No.: PCT/US2016/046812

§ 371 Date: Jan. 10, 2019

(51) Int. Cl. E21B 47/08; E21B 47/12; G01V 3/28; G01V 3/38

(52) U.S. Cl. CPC E21B 47/082; G01V 3/38; G01V 3/28; E21B 47/122

(57) ABSTRACT

In pipe characterization based on the remote-field eddy current effect, the resolution with which the total pipe thickness can be determined from measurements of the phase of the mutual impedance between the transmitter and the receiver of an eddy-current logging tool can be improved with a deconvolution approach utilizing the simulated or measured impulse response of a small pipe defect.

### BACKGROUND

The integrity of metal pipes in oil and gas wells is of great importance. Perforations or cracks in production tubing due to corrosion, for example, can cause significant loss of revenue due to loss of hydrocarbons and/or production of unwanted water. The corrosion of the well casing can be an indication of a detective cement bond between the casing and the borehole wall, which is likewise of concern because it can allow uncontrolled migration of fluids between different formation zones or layers. Near the surface, uncontrolled fluid migration can cause contamination of agricultural or drinking water reserves. To prevent damage associated with pipe (e.g., production tubing or casing) corrosion, it is good practice to periodically assess the integrity of the pipes to determine places where intervention is necessary to repair damaged sections.

Pipe inspection is commonly accomplished with electromagnetic techniques based on either magnetic flux leakage (MFL) or eddy currents (EC). While MFL techniques tend to be more suitable for single-pipe inspections, EC techniques allow for the characterization of multiple nested pipes. Eddy-current techniques can be divided into frequency-domain EC techniques and time-domain EC techniques. In frequency-domain EC techniques, a transmitter coil is fed by a continuous sinusoidal signal, producing time-variable primary fields that illuminate the pipes. The primary fields induce eddy currents in the pipes. These eddy currents, in turn, produce secondary fields that are sensed along with the primary fields in one or more receiver coils placed at a distance from the transmitter coil. Characterization of the pipes is performed by measuring and processing these fields. In time-domain EC techniques, the transmitter is fed by a pulse, producing transient primary fields, which, in turn, induce eddy currents in the pipes. The eddy currents then produce secondary magnetic fields, which can be measured by either a separate receiver coil placed further away from the transmitter, a separate receiver coil co-located with the transmitter, or the same coil as was used as the transmitter.

In frequency-domain EC pipe inspection, when the frequency of the excitation is adjusted so that multiple reflections in the wall of the pipe are insignificant and the spacing between the transmitter and receiver coils is large enough that the contribution to the mutual impedance from the dominant (but evanescent) waveguide mode is small compared to the contribution to the mutual impedance from the branch cut component (associated with the branch point singularity of the Fourier transform of the magnetic vector potential), the remote-field eddy current (RFEC) effect can be observed. In the RFEC regime, the mutual impedance between the transmitter coil and the receiver coil is very sensitive to the total thickness of the pipe wall, i.e., the sum of the thickness of the individual pipes. More specifically, the phase of the impedance varies approximately linearly with the total pipe thickness. This quasi-linear variation can be employed to perform fast inversion of the measured phase of the mutual impedance for the total thickness. In general, the larger the distance between transmitter and receiver, the better is the linear approximation. However, a larger transmitter-receiver distance tends to degrade the spatial resolution of the thickness estimation.

### BRIEF DESCRIPTION OF THE DRAWINGS

FIG. 1 is a schematic diagram of an electromagnetic pipe inspection system deployed in an example borehole environment, in accordance with various embodiments.

FIG. 2 is a graph of the linear relationship between the phase of the mutual impedance between a transmitter and a receiver of an eddy-current logging tool disposed in a set of pipes and the total pipe thickness, as used in accordance with various embodiments.

FIGS. 3A-3E are diagrams of an eddy-current logging tool adjacent to a segment of pipe having a defect smaller than the distance between the transmitter and the receiver, illustrating various axial positions of the tool relative to the defect.

FIG. 3F is a graph of the phase measured by the eddy-current logging tool of FIGS. 3A-3E as a function of the various axial positions, illustrating the double-indication effect.

FIGS. 4A-4E are diagrams of an eddy-current logging tool adjacent to a segment of pipe having a defect larger than the distance between the transmitter and the receiver, illustrating various axial positions of the tool relative to the defect.

FIG. 4F is a graph of the phase measured by the eddy-current logging tool of FIGS. 4A-4E as a function of the various axial positions, illustrating various levels of the measured phase.

FIG. 5 is a flow chart of a method for improved-resolution RFEC-based inversion in accordance with various embodiments.

FIG. 6 is a diagram of an eddy-current logging tool in an example configuration of five nested pipes having a defect in the third pipe, in accordance with various embodiments.

FIGS. 7A-7C are graphs of the true total thickness variation of a simulated example configuration of five nested pipes having a defect of length 120 on the fifth pipe, the corresponding initial estimated total-thickness variation, and the restored total-thickness variation computed using impulse-response total-thickness variations for small detects of length 20 on the first, third, and fifth pipe, respectively.

FIGS. 8A-8C are graphs of the true total-thickness variation of a simulated example configuration of five nested pipes having a defect of length 50 on the fifth pipe, the corresponding initial estimated total-thickness variation, and the restored total-thickness variation computed using impulse-response total-thickness variations for small defects of length 20 on the first, third, and fifth pipe, respectively.

FIG. 9 is graph of the true total-thickness variation of a simulated example configuration of five nested pipes having a detect of length 50 on the fifth pipe, the corresponding initial estimated total-thickness variation, and the combined restored total-thickness variation resulting from a least-squares solution in the Fourier domain, in accordance with various embodiments.

FIG. 10 is a graph of the true total-thickness variation of a simulated example configuration of five nested pipes having a defect of length 120 on the fifth pipe, the corresponding initial estimated total-thickness variations resulting from measurements with two receivers, the individual restored total-thickness variations for the two receivers, and the combined restored total-thickness variation resulting from a least-square solution in the Fourier domain, in accordance with various embodiments.

FIGS. 11A-11D are graphs of the true total-thickness variation of a simulated example configuration of five nested pipes having a detect of lengths 20, 50, 90, and 120, respectively, on the fifth pipe, the corresponding, initial estimated total-thickness variations, and the restored total-thickness variation computed using impulse-response total-thickness variations for small defects of length 10 on various pipes, in accordance with various embodiments.

FIG. 12 is a graph of an example level correction coefficient as a function of the length of the detect, as may be used in total-thickness level adjustment in accordance with various embodiments.

FIG. 13 is a flow chart of a method for post-processing the restored total-thickness variation resulting from the method of FIG. 5 to improve the thickness-change estimate, in accordance with various embodiments.

FIG. 14 is a block diagram of an example processing facility for the RFEC-based pipe thickness determination, in accordance with various embodiments.

### DETAILED DESCRIPTION

Described herein are approaches to improving the spatial resolution and accuracy of overall thickness estimations with RFEC-based inversion that take advantage of the fact that, for linear measurement systems, the measured output is the convolution of the input and the impulse response of the system. In the context of RFEC-based inversion involving measurements with an eddy-current logging tool disposed in a set of one or more pipes, the measured output corresponds to the total-pipe-thickness-dependent phase of the mutual impedance between transmitter and receiver of the tool, measured as a function of axial position along the pipe; the input corresponds to the pipe thickness as a function of the axial position; and the impulse response corresponds to the phase of the mutual impedance that would result from a “small defect” in pipe thickness; understood to be a deviation of the total pipe thickness from the nominal total pipe thickness over a short (theoretically infinitesimal, but in practice short finite) axial range. Accordingly, in various embodiments, the total-thickness variation along the axis is restored by deconvolving an initial estimated total-thickness variation computed from the measured phase of the mutual impedance (based on the linear relationship between that phase and the total pipe thickness) with the impulse-response total-thickness variation computed from the impulse-response phase. Herein, the impulse-response phase is approximated by the phase of the mutual impedance simulated for the shortest (or near-shortest) defect along the axial direction that still causes a measurable (above-noise) response, and which is, in any event, substantially shorter than the distance between transmitter and receiver (e.g., less than 50% of the receiver-transmitter distance).

In some embodiments, the mutual impedance is measured between multiple transmitter-receiver pairs of the tool and/or at multiple frequencies. For each of these measurements, the initial estimated total-thickness variation can be computed and deconvolved with the impulse-response total-thickness variation to yield a corresponding restored total-thickness variation. The results can be combined in a simple or weighted average to obtain a single restored total-thickness variation. Further, in cases where it is unknown which of multiple nested pipes is defective, multiple impulse responses can be computed for multiple locations of the small defect, and the multiple corresponding individual restored total-thickness variations can be combined in a simple or weighted average to obtain a single restored total-thickness variation; the weights can be set based on some knowledge of the likely location of the defect to be measured. Of course, averaging over multiple defect locations can also be combined with averaging over multiple transmitter-receiver pairs or multiple frequencies, with or without weighting. Moreover, in some embodiments, the restored total-thickness variation is further processed to correct for its magnitude based on an estimated length of the defect.

The preceding will be more readily understood from the following detailed description of various examples embodiments, in particular, when taken in conjunction with the accompanying drawings.

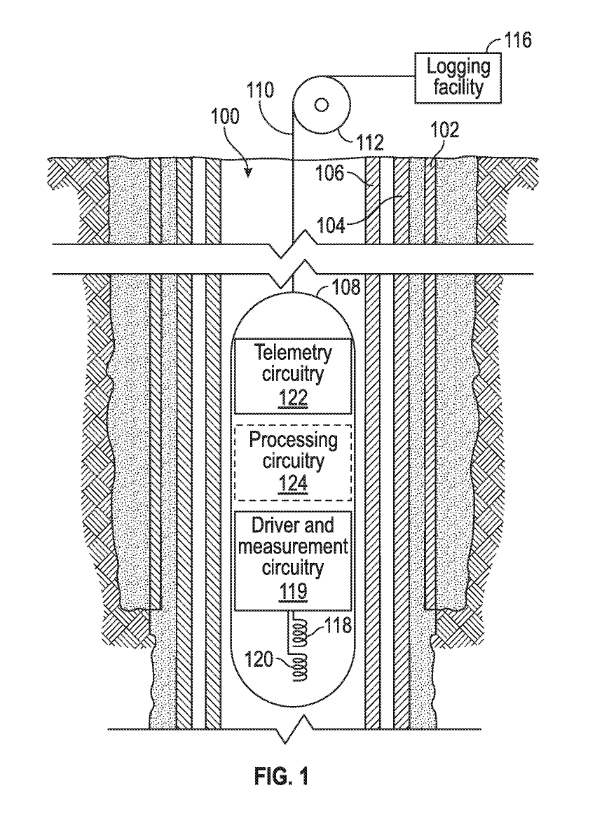

FIG. 1 is a diagram of an electromagnetic pipe inspection system deployed in an example borehole environment, in accordance with various embodiments. The borehole 100 is shown during a wireline logging operation, which is carried out after drilling has been completed and the drill string has been pulled out. As depicted, the borehole 100 has been completed with surface casing 102 and intermediate casing 104, both cemented in place. Further, a production pipe 106 has been installed in the borehole 100. While three pipes 102, 104, 106 are shown in this example, the number of nested pipes may generally vary, depending, e.g., on the depth of the borehole 100. As a result, the nominal total thickness of the pipes may also vary as a function of depth.

Wireline logging generally involves measuring physical parameters of the borehole 100 and/or surrounding formation—such as, in the instant case, the total thickness of the pipes 102, 104, 106—as a function of depth within the borehole 100. The pipe measurements may be made by lowering an electromagnetic logging tool 108 into the wellbore 100, for instance, on a wireline 110 wound around a winch 112 mounted on a logging truck. The wireline 110 is an electrical cable that, in addition to delivering the tool 108 downhole, may serve to provide power to the tool 108 and transmit control signals and/or data between the tool 108 and a logging facility 116 (implemented, e.g., with a suitably, programmed general-purpose computer including one or more processors and memory) located above surface, e.g., inside the logging truck. In some embodiments, the tool 108 is lowered to the bottom of the region of interest and subsequently pulled upward, e.g., at substantially constant speed. During this upward trip, the tool 108 may perform measurements on the pipes, either at discrete positions at which the tool 108 halts, or continuously as the pipes pass by.

In accordance with various embodiments, the electromagnetic logging tool 108 used for pipe inspection is a frequency-domain eddy-current tool configured to generate, as the electromagnetic excitation signal, an alternating primary field that induces eddy currents inside the metallic pipes, and to record, as the electromagnetic response signal, secondary fields generated from the pipes; these secondary fields bear information about the electrical properties and metal content of the pipes, and can be inverted for any corrosion or loss in metal content of the pipes. The tool 108 generally includes one or more transmitters (e.g., transmitter coil 118) that transmit the excitation signals and one or more receivers e.g., receiver coil 120) to capture the response signals. The transmitter and receiver coils 118, 120 are spaced apart along the axis of the tool 108 and, thus, located at slightly different depths within the borehole 100; the transmitter-receiver distance may be, e.g., in the range from 20 inches to 80 inches. The tool may be configured to operate at multiple frequencies, e.g., between about 0.5 Hz and about 4 Hz. The tool 108 further includes, associated with the transmitter(s) and receiver(s), driver and measurement circuitry 119 configured to operate the tool 108 at the selected frequency.

The tool 108 may further include telemetry circuitry 122 for transmitting information about the measured electromagnetic response signals to the logging facility 116 for processing and/or storage thereat, or memory (not shown) for storing this information downhole for subsequent data retrieval once the tool 108 has been brought back to the surface. Optionally, the tool 108 may contain analog or digital processing circuitry 124 (e.g., an embedded microcontroller executing suitable software) that allows the measured response signals to be processed at least partially downhole (e.g., prior to transmission to the surface). From a sequence of measurements correlated with the depths along the borehole 100 at which they are taken (corresponding to different axial positions along the pipe), a log of the pipe thickness can be generated. The computer or other circuitry used to process the electromagnetic excitation and response signals to compute the phase of the mutual impedance between transmitter and receiver and derive the total pipe thickness based thereon is hereinafter referred to as the processing facility, regardless whether it is contained within the tool 108 as processing circuitry 124, provided in a separate device such as logging facility 116, or both in part. Collectively, the electromagnetic logging tool 108 and processing facility (e.g., 124 and/or 116) are herein referred to as a pipe inspection system.

Alternatively to being conveyed downhole on a wireline, as described above, the electromagnetic logging tool 108 can be deployed using other types of conveyance, as will be readily appreciated by those of ordinary skill in the art. For example, the tool 108 may be lowered into the borehole 100 by slickline (a solid mechanical wire that generally does not enable power and signal transmission), and may include a battery or other independent power supply as well as memory to store the measurements until the tool 108 has been brought back up to the surface and the data retrieved. Alternative means of conveyance include, for example, coiled tubing or downhole tractor.

In accordance with RFEC techniques as described herein, the electromagnetic excitation and response signals are processed to determine the mutual impedance between transmitter and receiver coils. From the phase of the mutual impedance, the total thickness of the pipes (that is, in the case of multiple nested pipes, the sum of their individual thicknesses) can be computed. The variation of the phase φ and magnitude |Z| of the mutual impedance as a function of total pipe thickness can be approximated by a linear expression:

$$ϕ = 2 \sqrt{\frac{ωμσ}{2}} t = 2 \frac{δ}{t}$$

$$\vert Z \vert = {e}^{- 2 \sqrt{ωμσ / 2 t}} = {e}^{- 2 t / δ}$$

where ω is the angular frequency of the excitation source, μ is the magnetic permeability of the pipe(s), σ is the electrical conductivity of the pipe(s), t is the total thickness of the pipe(s), and δ is the skin depth of the metal, defined as δ=\sqrt{2/(ωμσ)}.

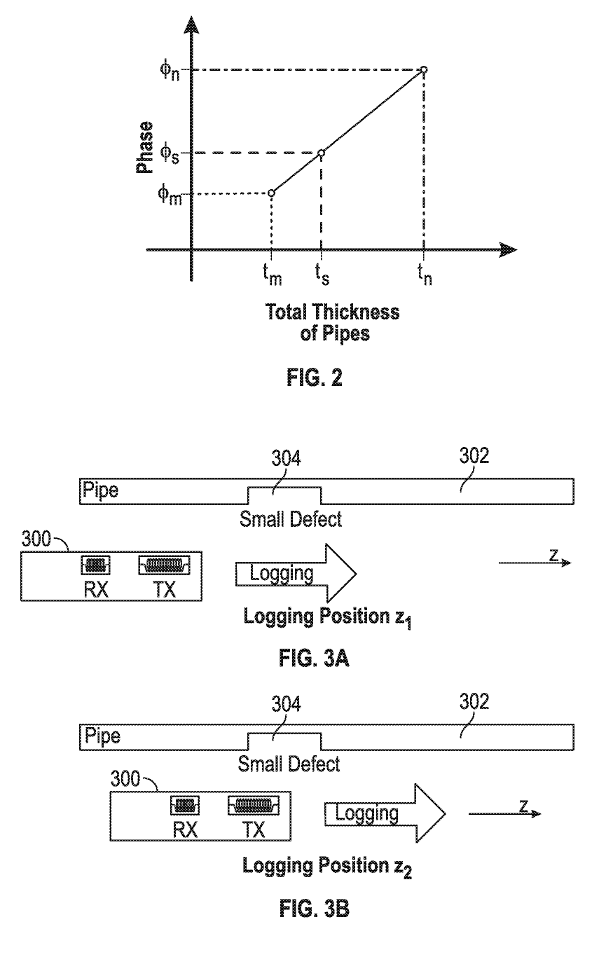

FIG. 2 is a graph of the linear relationship that approximates the phase of the mutual impedance between a transmitter and a receiver of an eddy-current logging tool disposed in a set of pipes as a function of the total pipe thickness. This linear relationship can be constructed for any given set of pipe dimensions, material properties, and tool configuration, based on a computational model of the tool and set of pipes, and can thereafter be used to perform fast inversions of measured phases for corresponding estimates of the total thickness of the pipes. The linear relationship may be established, in accordance with various embodiments, by performing two simulations (based on the computational model): one simulation for a nominal section of the pipes, i.e., a section where the total thickness is the nominal thickness tₙ, and a second simulation for an assumed defective section of the pipes with a total thickness tₘ, which may be selected such that the thickness change Δt=tₙ−tₘ is larger than the largest possible total thickness change for the test configuration. With the simulated phases φₙ and φₘ corresponding to the total thicknesses tₙ and tₘ, respectively, a straight line can be established between the points (tₙ, φₙ) and (tₘ, φₘ), as shown in FIG. 2. This line can then be employed to invert any measured phase within the range between phases φₙ and φₘ (if necessary, after phase-unwrapping) to the total thickness of the pipes, enabling thickness estimations for defective pipe section. For example, FIG. 2 shows that a measured phase φₛ be inverted to a total thickness thickness tₛ of the defective section when using this linear approximation.

In the RFEC regime, the distance between the transmitter and receiver should be sufficiently large for the linear relationship between the phase of the mutual impedance and the total thickness to hold. Increasing the transmitter-receiver distance to improve the linear approximation, however, comes at the cost degraded resolution of the thickness estimation. This resolution degradation affects the thickness estimations for small defects (defects much shorter than the transmitter-receiver distance along the axial direction) and large defects (defects on the order or longer than the transmitter-receiver distance along the axial direction differently.

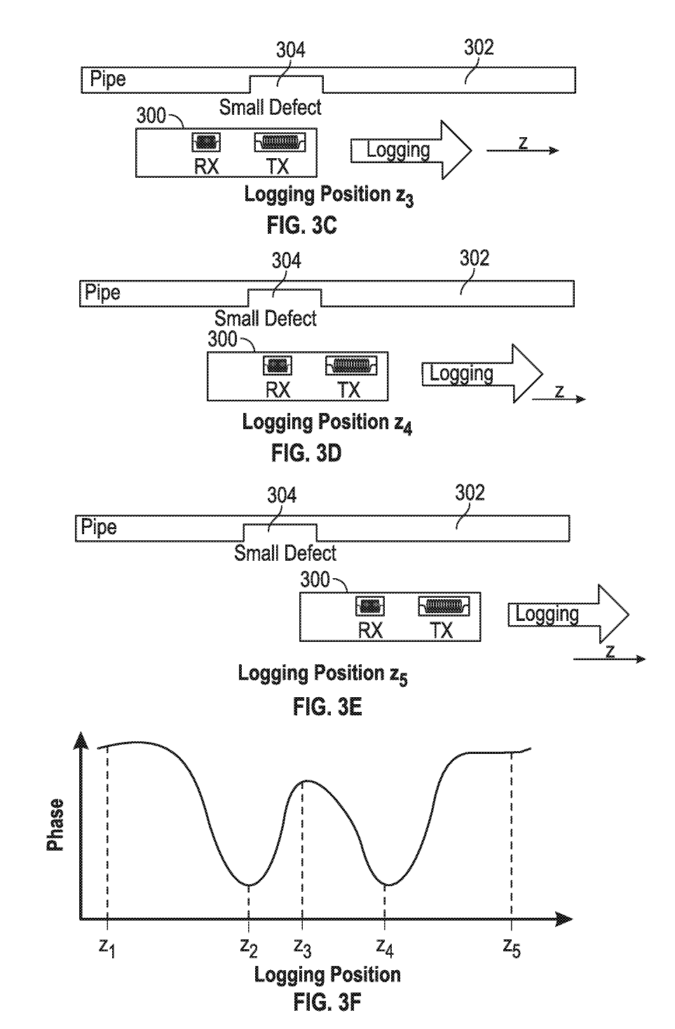

FIGS. 3A-3F illustrate the resolution degradation effect observed for small defects. In FIGS. 3A-3E, an eddy-current logging tool 300 is shown adjacent a segment of pipe 302 (the wall of the pipe 302 being depicted only at one side of the tool 300) with a small defect 304, at various axial positions of the tool 300 relative to the defect 304 (corresponding to different logging positions). The defect 304 is smaller than the distance between the transmitter TX and the receiver RX of the tool, such that either the transmitter TX or the receive RX can be in front of the detect 304, but not both. FIG. 3F shows the resulting phase measured by the eddy-current logging tool 300 (relative to that of a phase measured for a nominal pipe section) as a function of axial position, with positions z₁ through z₅ corresponding to FIGS. 3A trough 3E, respectively. The phase variation with axial position exhibits two separate dips, at logging positions z₂ and z₄. This effect is usually referred to as the “double indication effect” or “ghost effect,” as the two dips are due to only a single defect. The dip at logging position z₂ is observed when the transmitter TX is in front of the defect 304 (FIG. 3B), and the dip at logging position z₄ is observed when the receiver RX is in front of the defect 304 (FIG. 3D). When inverting the phase variation to total thickness changes in a point-by-point way using conventional RFEC-based inversion, the single defect 304 will, due to the double indication effect, appear as two defects. Besides, since the RFEC-based inversion line is usually developed for defects of infinite length, the estimated thickness change (relative to the nominal thickness) for the small defects will be one-half of the true thickness change since the total thickness change due to the small defect is translated as if there is a large defect with half of that thickness change covering both the transmitter and the receiver. In addition to the resolution degradation, for very small defects, the estimated total thickness is less than the true thickness change, as will be shown below.

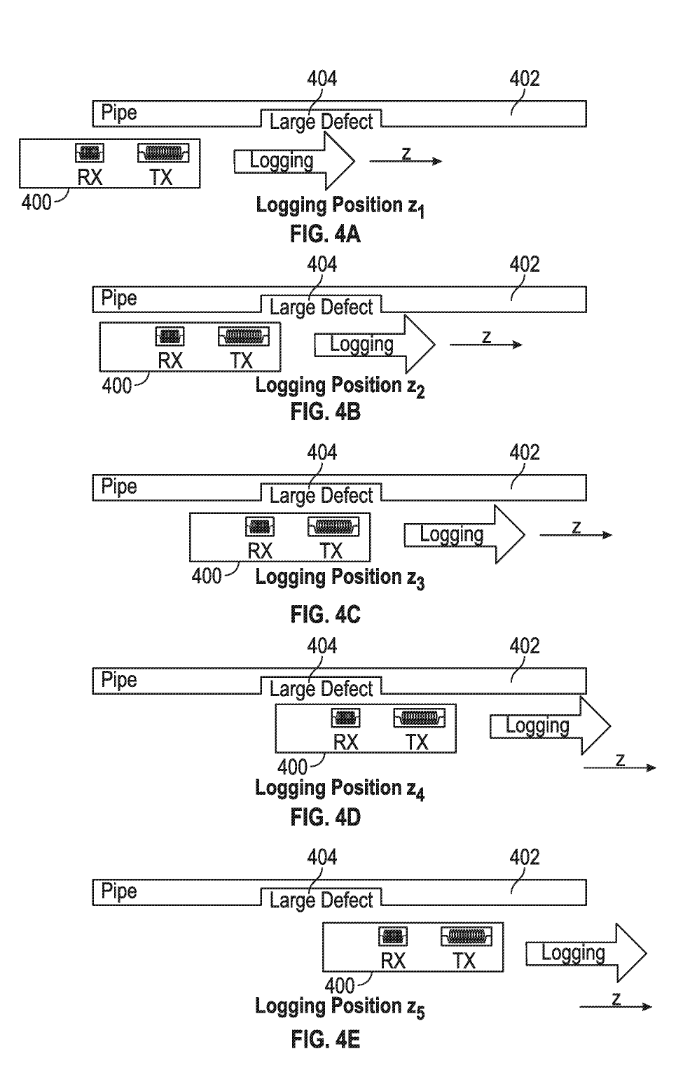

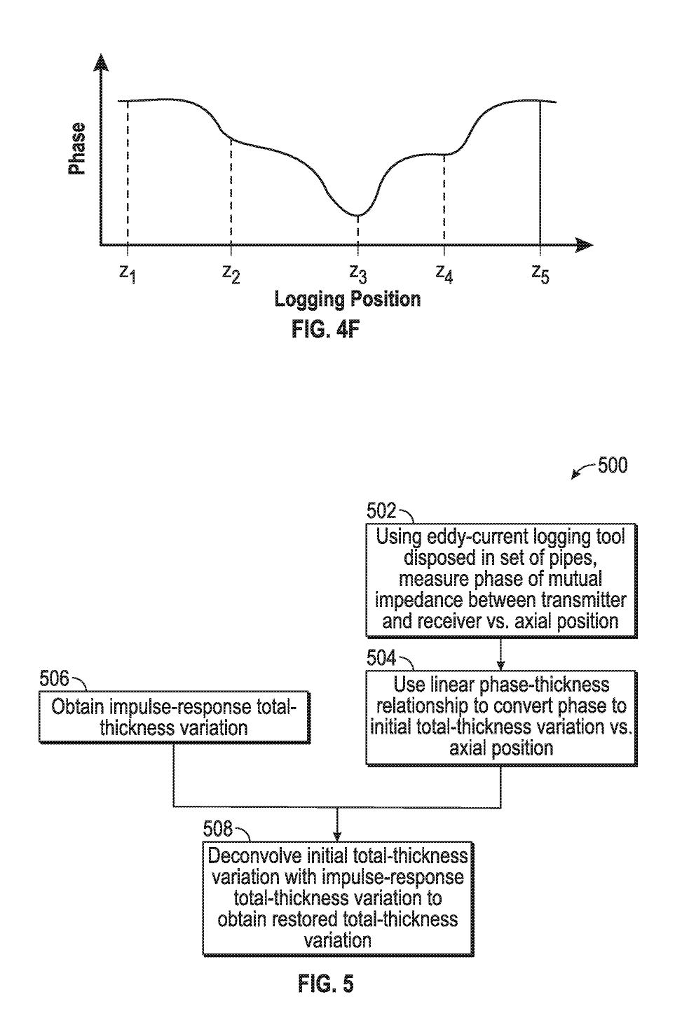

FIGS. 4A-4F illustrate the resolution degradation effect observed for the large defects. FIGS. 4A-4E show of an eddy-current logging tool 400 adjacent a segment of pipe 402 having a defect 404 larger than the distance between the transmitter TX and the receiver RX, illustrating various axial positions of the tool 400 relative to the defect 404. FIG. 4F is a graph of the phase of the mutual impedance as a function of the various axial positions, illustrating various levels of the measured phase. The values of the phase at axial positions z₂ and z₄ are attributed to the cases in which only the transmitter TX or only the receiver RX, respectively, is in front of the defect 404. At these positions, the estimated total thickness change for the pipe (relative to the nominal thickness) is approximately one-half of the true thickness change, for reasons similar to that stated above for small defects. At axial position z₃, both the transmitter TX and the receiver RX are in front of the defect 404; therefore, at z₃, the maximum phase change relative to the phase for the nominal configuration is observed, and the estimated thickness change is the closet to its true value.

In accordance with various embodiments, the resolution in RFEC-based total-thickness determination is improved, and the double-indication effect for small defects is eliminated, with deconvolution approaches that employ the approximate impulse response of the measurement system. The impulse response of the measurement system is, theoretically, the response resulting from an infinitesimally short defect, and can be approximated with the response for a small defect, preferably the shortest (or near-shortest) defect along the axial direction that causes a response still above noise and measurable with good accuracy. The response for an arbitrary defect of any length and shape is the convolution of the impulse response with the shape of the defect. Accordingly, by deconvolving the measured response for an arbitrary defect with the impulse response, the actual defect can be restored. For a given set of pipes and tool configuration, and a given receiver of the tool and operation frequency, the deconvolution process can be implemented on the phase responses. In the UK regime, the linear phase-thickness relationship (e.g., as shown in FIG. can be employed to perform deconvolution on the impulse response total-thickness variation Tₛ(z) and an initial total-thickness variation Tₗ(z) computed from the measured phase:

Tₗ(z)=Tₛ(z)*Tᵣ(z),

where Tᵣ(Z) is the restored total-thickness variation, which has better resolution along the axial direction than Tₗ(z). The restored total-thickness variation can be determined with any one of various well-known deconvolution methods.

FIG. 5 is a flow chart illustrating, at a high level, a method 500 for improved-resolution RFEC-based inversion in accordance with various embodiments. The method 500 involves measuring the phase of the mutual impedance between the transmitter and a receiver of an eddy-current logging tool disposed in a set of (one or more) pipes as a function of the axial position of the tool within the pipes (act 502), and converting it to an initial estimated total-thickness variation vs. axial position based on a linear phase-thickness relationship, as is valid (at least approximately) in the RFEC regime (act 504). Further, the method 500 includes obtaining an (approximate) impulse-response total-thickness variation for the set of pipes (act 506). The impulse-response total-thickness variation can be computed, using the linear phase-thickness relationship, from an impulse-response phase either measured or simulated for a small defect (as described above); if simulated, a suitable computational model of the set of pipes is employed. The initial total-thickness variation obtained in act 504 is then deconvolved with the impulse-response total-thickness variation obtained in act 506 to obtain a restored total-thickness variation (act 508). In some embodiments, the deconvolution is carried out by converting the initial total-thickness variation and the impulse-response total-thickness variation by Fourier transform into the spatial-frequency domain (“Fourier domain”), dividing the Fourier-transformed initial total-thickness variation by the Fourier-transformed impulse-response total-thickness variation (where “dividing” is to be understood broadly in some circumstances, described further below), and applying inverse Fourier transform to the result. Furthermore, in certain embodiments, the deconvolution with an impulse response can be performed on the phase, and the resulting restored phase thereafter converted into a restored total-thickness variation.

When estimating the total thickness of a set of multiple nested pipes to detect defects, it is generally not known on which pipe a given defect is located. The location of the defect affects, however, the deconvolution approach described above and, in particular, the impulse response. In accordance with various embodiments, therefore, the impulse-response total-thickness variation is determined for multiple selections of the pipe on which the defect might be located (and possibly for each pipe of the set), and the restored total-thickness variation is computed based on a combination of the various assumed locations of the defect. Furthermore, in various embodiments, the phase of the mutual impedance is measured for multiple receivers of the eddy-current tool and/or at multiple frequencies. The results of these measurements can likewise be combined. In some embodiments, the total-thickness variation is restored individually for each receiver, frequency, and selection of the pipe on which the defect is located, and the results are thereafter averaged (optionally in a weighted manner). In other embodiments, a single restored total-thickness variation is determined by simultaneously solving a system of equations for the multiple receivers, frequencies, and/or pipe selections. The various methods are described in detail herein below.

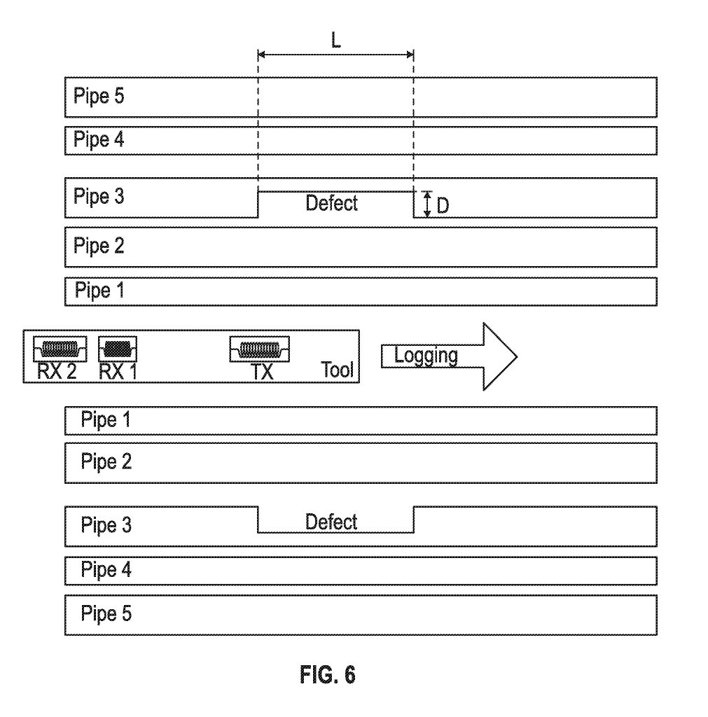

FIGS. 6-8C illustrate the importance of the localization of the defect for the results of the deconvolution with simulation results obtained for an example configuration of five nested pipes and an eddy-current logging tool with two receivers RX1 and RX2, as shown in FIG. 6. The pipes have outer diameters (ODs) of 2+⅞ inches, 7 inches, 9+⅝ inches, 13+⅜ inches, and 18+⅝ inches and nominal thicknesses of 0.21 inches, 0.32 inches, 0.54 inches, 0.51 inches, and 0.43 inches, respectively. The parameters of the tool are shown in Table 1.

TABLE 1

| | | | | Position with |
|---|---|---|---|---|
| Coil | OD (inches) | Number of turns | Length (inches) | respect to TX |
| TX | 1.28 | 5200 | 16 | 0 |
| RX1 | 0.978 | 17700 | 8 | 50 |
| RX2 | 0.978 | 27000 | 12 | 62 |

For purposes of different simulations, the defect is assumed to be on various one of the five pipes; in FIG. 6, the defect is shown on the third pipe. The thickness change in the defective region is denoted by D and is set to 10% of the nominal thickness of the corresponding pipe for each simulation. The length of the defective region is denoted by L and is changing between different simulation cases.

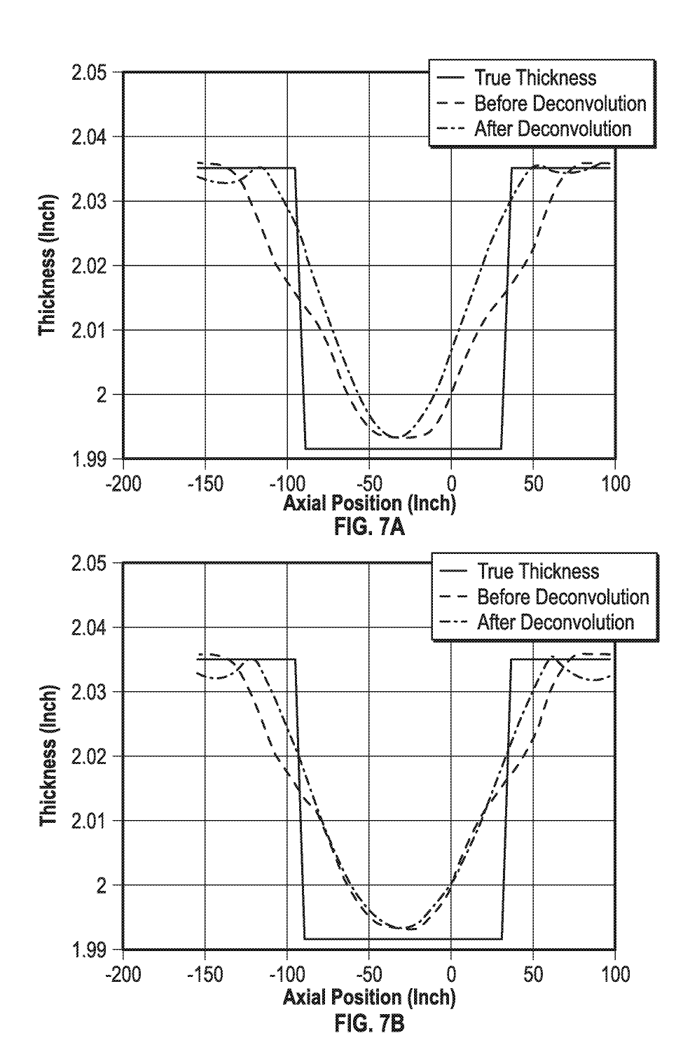

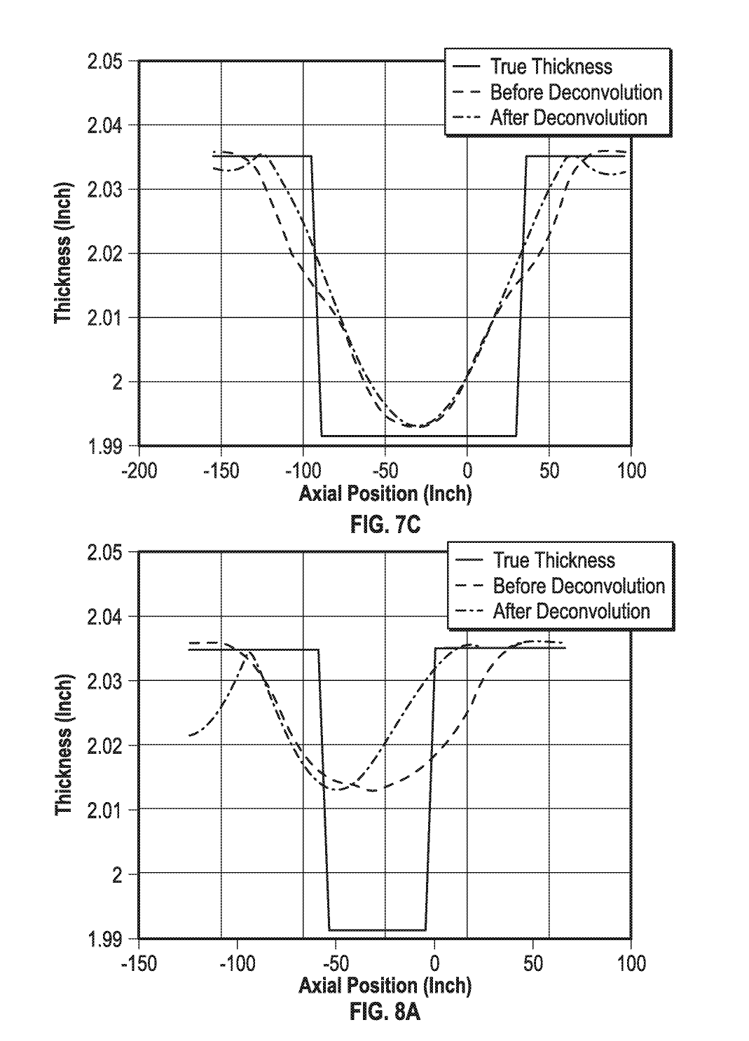

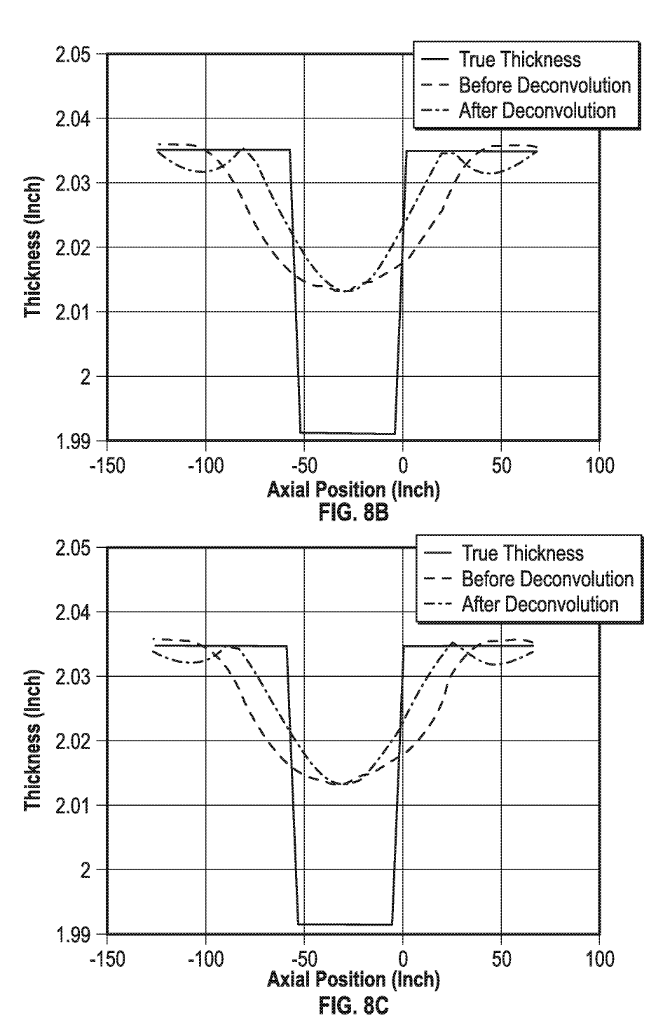

FIGS. 7A-7C show the true total-thickness variation, initial estimated total-thickness variation, and restored total-thickness variation for a defect of length L=120 inches on the fifth pipe. The restored total-thickness variation is computed by deconvolution using a small defect 20 inches in length, assumed to be on the first, third, and fifth pipe for FIGS. 7A, 7B, and 7C, respectively. FIGS. 8A-8C show the true total-thickness variation, initial estimated total-thickness variation, and restored total-thickness variation for a defect of length L=50 inches on the fifth pipe, likewise assuming a small defect of length 20 on the first, third, and fifth pipe, respectively. The graphs show an improvement in the resolution of the thickness variation along the axial direction after deconvolution. The level of the estimated total thickness change in FIGS. 8A-8C has larger errors due to the smaller size of the defect. FIG. 8A furthermore shows an error in the axial position of the defect in the restored total-thickness variation obtained by deconvolution, illustrating the effect of a the (improper) selection of the pipe on which the defect is assumed to be located: in the simulation underlying FIG. 8A, the impulse response is computed for a small defect on the first pipe, whereas the actual defect is on the fifth pipe.

In accordance with various embodiments, the robustness of the restoration process for (the usual) cases where the pipe that is defective is unknown is improved over an approach that assumes the defect being located on a particular pipe by combining the restoration results across multiple assumptive locations of the defect. Denoting the number of pipes by Nₚ and the impulse-response total-thickness variation for a small detect on pipe k=1, . . . Nₚ by Tₛ^{k}(z), the convolution can be expressed for each assumptive location of the defect:

$$\{ \begin{matrix}{T}_{l} ( z ) = {T}_{s}^{1} ( z ) * {T}_{r}^{1} ( z ) \\ ⋮ \\ {T}_{l} ( z ) = {T}_{s}^{k} ( z ) * {T}_{r}^{k} ( z ) \\ ⋮ \\ {T}_{l} ( z ) = {T}_{s}^{Np} ( z ) * {T}_{r}^{Np} ( z )\end{matrix}$$

The deconvolution problem related to each equation can be solved separately for each value of k, resulting in Nₚ individual restored total-thickness variations Tᵣ^{k} (z), k=1, . . . , Nₚ. These results can then be combined, with proper weighting coefficients, to provide a final, overall restored total-thickness variation:

Tᵣ^{f}(z)=Σₖ₌₁^{Np}w^{k}Tᵣ^{k}(z).

With weighting coefficients all taken to be the same and equal to w^{k}=1/Nₚ for k=1, . . . , Nₚ, the final restored total-thickness variation Tᵣ^{f} is simply the arithmetic average of the individual restored total-thickness variations for the different assumptive defect locations. Alternatively, any prior knowledge of the location of the defect may be used in determining the best weighting coefficients to tune the contributions of small detects assumed to be located on different respective pipes in the final result. For example, if sections of the eddy-current tool are designed to detect defects on the inner pipes only or on the outer pipes only, the weighting coefficients associated with restored total-thickness variations computed for the assumption of a small defect on those pipes is boosted relative to the rest.

In accordance with various embodiments, the phase variation of the mutual impedance versus axial location along the pipes is measured by multiple receivers RXi, i=1, . . . , Nᵣ (where Nᵣ is the number of receivers), and/or at multiple frequencies fⱼ, j=1, . . . , N₁ (where N_{f} is the number of frequencies). Combining the RFEC-based total-thickness estimates across these multiple receivers and/or frequencies can improve the quality of the result. Denoting, for data collected by receiver RXi at frequency fⱼ, the impulse-response total-thickness variation for a small defect by Tₛ^{i,j}(z) and the initial estimated total-thickness variation for the (large) tested detect by Tₗ^{i,j}(z), the convolution can be expressed for each combination of receiver and frequency:

$$\{ \begin{matrix}{T}_{l}^{1 , 1} ( z ) = {T}_{s}^{1 , 1} ( z ) * {T}_{r}^{1 , 1} ( z ) \\ ⋮ \\ {T}_{l}^{i , j} ( z ) = {T}_{s}^{i , j} ( z ) * {T}_{r}^{i , j} ( z ) \\ ⋮ \\ {T}_{l}^{Nr , Nf} ( z ) = {T}_{s}^{Nr , Nf} ( z ) * {T}_{r}^{Nr , Nf} ( z )\end{matrix}$$

The deconvolution problem related to each equation can be solved separately for each pair of values of i and j, resulting in Nᵣ·N_{f} individual restored total-thickness variations Tᵣ^{i,j}(z) These results can then be combined, with proper weighting coefficients, to provide a final, overall restored total-thickness variation:

Tᵣ^{f}(z)=Σᵢ₌₁^{NR}Σⱼ₌₁^{Nf}w^{i,j}Tᵣ^{i,j}(z).

With weighting coefficients all taken to be the same and equal to w^{i,j}=1/(Nᵣ·N_{f}) for i=1, . . . , Nᵣ and j=1, . . . , N_{f}, the final restored total-thickness variation Tᵣ^{f} is simply the arithmetic average of the individual restored total-thickness variations for the various receivers and frequencies. Alternatively, any prior knowledge of the relative accuracies of results obtained with different receivers or frequencies may be used in determining the best weighting coefficients to tune the contributions of the various receivers and frequencies in the final result.

Of course, total-thickness estimates can also be combined simultaneously across multiple assumptive locations of the defect and across multiple receivers and/or multiple frequencies. For each combination of receiver RXi, frequency fⱼ, and assumptive location of the defect on pipe k, the convolution can be expressed as:

Tₗ^{i,j}(z)=Tₛ^{i,j,k}(z)*Tᵣ^{i,j,k}(z).

Each equation can be solved separately to restore Tᵣ^{i,j,k}, and the individual restored total-thickness variations can then be averaged, with proper weighting coefficients w^{i,j,k} according to:

Tᵣ^{f}(z)=Σᵢ^{NR}Σⱼ^{NF}Σₖ^{NP}w^{i,j,k}Tᵣ^{i,j,k}(z).

Various embodiments involve combining the deconvolution process for multiple receivers, frequencies, and/or defect locations using a least-square or similar difference metric in Fourier space, instead of averaging over individual restored thickness-variations obtained separately for each combination of receiver, frequency, and defect location. Considering first the combination across multiple selections of the pipe on which the defect is assumed to be located, a single restored total-thickness variation Tᵣ(z) that simultaneously satisfies, at least in an approximate sense, the equation Tₗ(z)=Tₛ^{k}(z)*Tᵣ(z) for all values of k is sought. By taking the Fourier transform with respect to z on both sides of the equation, the following system of equations is obtained for each value of the spatial frequency k_{z} (the Fourier variable corresponding to z):

$$[ \begin{matrix}{\tilde{T}}_{s}^{1} ( {k}_{z} ) \\ ⋮ \\ {\tilde{T}}_{s}^{k} ( {k}_{z} ) \\ ⋮ \\ {\tilde{T}}_{s}^{Np} ( {k}_{z} )\end{matrix} ] \cdot {\tilde{T}}_{r} ( {k}_{z} ) = [ \begin{matrix}{\tilde{T}}_{l} ( {k}_{z} ) \\ ⋮ \\ {\tilde{T}}_{l} ( {k}_{z} ) \\ ⋮ \\ {\tilde{T}}_{l} ( {k}_{z} )\end{matrix} ]$$

This system of equation can be solved for each value of k_{z} in a least-squares sense or, more generally, in the sense that a suitable difference metric aggregating the difference between \tilde{T}ᵣ(k_{z}) and \tilde{T}ₗ(k_{z})/\tilde{T}ₛ^{k} over k (such as, e.g., the sum of squares Σₖ₌₁^{Np}(\tilde{T}ᵣ(k_{z})−\tilde{T}ₗ(k_{z})/\tilde{T}ₛ^{k})² for a least-squares optimization, or the sum of absolute differences) is minimized to obtain \tilde{T}ᵣ(k_{z}). Then, by taking the inverse Fourier transform of \tilde{T}ᵣ(k_{z}), the final restored total-thickness variation Tᵣ(z) can be obtained.

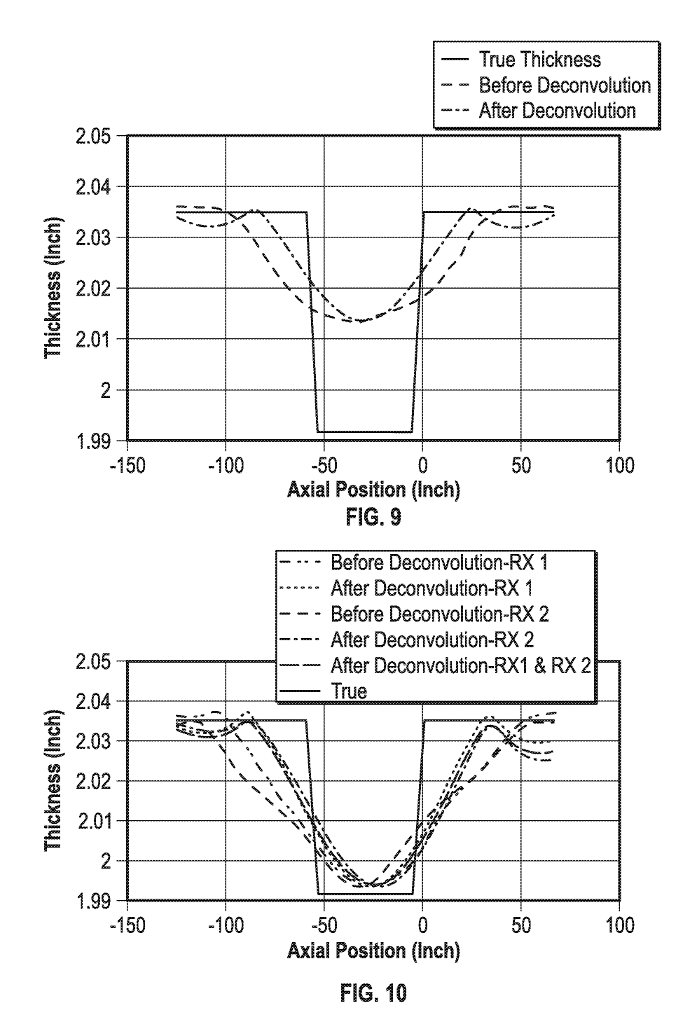

FIG. 9 illustrates this technique as applied to the characterization of five pipes as shown in FIG. 6 with a defect of length L=50 inches on the fifth pipe, using impulse responses for defects 20 inches in length applied to each pipe (one pipe per simulation). The resulting restored total-thickness variation, computed based on a least-squares solution to the equations for all locations of the detect in the Fourier domain, is more robust than that obtained when the defect is assumed to be on a particular one of the pipes, as illustrated, e.g., by comparison with FIG. 8A.

In some embodiments, the convolution process is combined across multiple receivers and frequencies (in a manner similar to the above-described approach for combining across multiple selections of the selective pipe) to determine a single restored total-thickness variation that simultaneously satisfies the following system of equations:

$$\{ \begin{matrix}{T}_{l}^{1 , 1} ( z ) = {T}_{s}^{1 , 1} ( z ) * {T}_{r} ( z ) \\ ⋮ \\ {T}_{l}^{i , j} ( z ) = {T}_{s}^{i , j} ( z ) * {T}_{r} ( z ) \\ ⋮ \\ {T}_{l}^{Nr , Nf} ( z ) = {T}_{s}^{Nr , Nf} ( z ) * {T}_{r} ( z )\end{matrix}$$

After Fourier transform with respect to z, the equations take the form:

$$[ \begin{matrix}{\tilde{T}}_{s}^{1 , 1} ( {k}_{z} ) \\ ⋮ \\ {\tilde{T}}_{s}^{i , j} ( {k}_{z} ) \\ ⋮ \\ {\tilde{T}}_{s}^{Nr , Nf} ( {k}_{z} )\end{matrix} ] \cdot {\tilde{T}}_{r} ( {k}_{z} ) = [ \begin{matrix}{\tilde{T}}_{l}^{1 , 1} ( {k}_{z} ) \\ ⋮ \\ {\tilde{T}}_{l}^{i , j} ( {k}_{z} ) \\ ⋮ \\ {\tilde{T}}_{l}^{Nr , Nf} ( {k}_{z} )\end{matrix} ]$$

This system of equation can be solved for each value of k_{z} in a least-squares sense or, more generally, to minimize a suitable difference metric aggregating the difference between \tilde{T}ₗ(k_{z})/\tilde{T}ₛ^{i,j} over all receivers i and j to obtain \tilde{T}ᵣ(k_{z}). Then, by taking the inverse Fourier transform of \tilde{T}ᵣ(k_{z}), the final restored total-thickness variation Tᵣ(z) can be obtained.

FIG. 10 shows, as an example of combining data across receivers, the results of characterizing the five pipes of FIG. 6 with the tool described in Table 1, assuming a defect of length L=120 inches on the fifth pipe and measurements performed at a frequency of 1 Hz. The initial and restored total-thickness variations for each of the two receivers RX1 and RX2 are shown alongside a combined restored total-thickness variation obtained by simultaneously deconvolving the initial total-thickness variations for the two receivers in a least-square sense, as described above. The restored total-thickness variation resulting from the simultaneous deconvolution for both receivers falls largely in between the restored total-thickness variations obtained for the individual receivers, and is therefore deemed a more robust estimation in a noisy environment.

As will be readily appreciated, it is also possible to compute a restored total-thickness variation based on measurements taken by multiple receivers and at multiple frequencies, and selecting multiple pipes for the location of the small defect from which the impulse response is computed. Requiring all restored total-thickness variations to be the same (i.e., Tᵣ^{i,j,k}(Z)=Tᵣ(z) for all i, j, and k), the following system of equations can be constructed:

$$\{ \begin{matrix}{T}_{l}^{1 , 1} ( z ) = {T}_{s}^{1 , 1 , 1} ( z ) * {T}_{r} ( z ) \\ ⋮ \\ {T}_{l}^{1 , 1} ( z ) = {T}_{s}^{1 , 1 , k} ( z ) * {T}_{r} ( z ) \\ ⋮ \\ {T}_{l}^{1 , 1} ( z ) = {T}_{s}^{1 , 1 , Np} ( z ) * {T}_{r} ( z ) \\ ⋮ \\ {T}_{l}^{i , j} ( z ) = {T}_{s}^{i , j , 1} ( z ) * {T}_{r} ( z ) \\ ⋮ \\ {T}_{l}^{i , j} ( z ) = {T}_{s}^{i , j , k} ( z ) * {T}_{r} ( z ) \\ ⋮ \\ {T}_{l}^{i , j} ( z ) = {T}_{s}^{i , j , Np} ( z ) * {T}_{r} ( z ) \\ ⋮ \\ {T}_{l}^{Nr , Nf} ( z ) = {T}_{s}^{Nr , Nf , 1} ( z ) * {T}_{r} ( z ) \\ ⋮ \\ {T}_{l}^{Nr , Nf} ( z ) = {T}_{s}^{Nr , Nf , k} ( z ) * {T}_{r} ( z ) \\ ⋮ \\ {T}_{l}^{Nr , Nf} ( z ) = {T}_{s}^{Nr , Nf , Np} ( z ) * {T}_{r} ( z )\end{matrix}$$

Fourier transform with respect to z yields:

$$[ \begin{matrix}{\tilde{T}}_{s}^{1 , 1 , 1} ( {k}_{z} ) \\ ⋮ \\ {\tilde{T}}_{s}^{1 , 1 , k} ( {k}_{z} ) \\ ⋮ \\ {\tilde{T}}_{s}^{1 , 1 , Np} ( {k}_{z} ) \\ ⋮ \\ {\tilde{T}}_{s}^{i , j , 1} ( {k}_{z} ) \\ ⋮ \\ {\tilde{T}}_{s}^{i , j , k} ( {k}_{z} ) \\ ⋮ \\ {\tilde{T}}_{s}^{i , j , Np} ( {k}_{z} ) \\ ⋮ \\ {\tilde{T}}_{s}^{Nr , Nf , 1} ( {k}_{z} ) \\ ⋮ \\ {\tilde{T}}_{s}^{Nr , Nf , k} ( {k}_{z} ) \\ ⋮ \\ {\tilde{T}}_{s}^{Nr , Nf , Np} ( {k}_{z} )\end{matrix} ] {\tilde{T}}_{r} ( {k}_{z} ) = [ \begin{matrix}{\tilde{T}}_{l}^{1 , 1 , 1} ( {k}_{z} ) \\ ⋮ \\ {\tilde{T}}_{l}^{1 , 1 , k} ( {k}_{z} ) \\ ⋮ \\ {\tilde{T}}_{l}^{1 , 1 , Np} ( {k}_{z} ) \\ ⋮ \\ {\tilde{T}}_{l}^{i , j} ( {k}_{z} ) \\ ⋮ \\ {\tilde{T}}_{l}^{i , j} ( {k}_{z} ) \\ ⋮ \\ {\tilde{T}}_{l}^{i , j} ( {k}_{z} ) \\ ⋮ \\ {\tilde{T}}_{l}^{Nr , Nf} ( {k}_{z} ) \\ ⋮ \\ {\tilde{T}}_{l}^{Nr , Nf} ( {k}_{z} ) \\ ⋮ \\ {\tilde{T}}_{l}^{Nr , Nf} ( {k}_{z} )\end{matrix} ]$$

This system of equations can be solved in least-square sense (or sing some other suitable distance metric) to estimate \tilde{T}ᵣ(k_{z}), from which the restored total-thickness variation Tᵣ(z) can be computed by inverse Fourier transform.

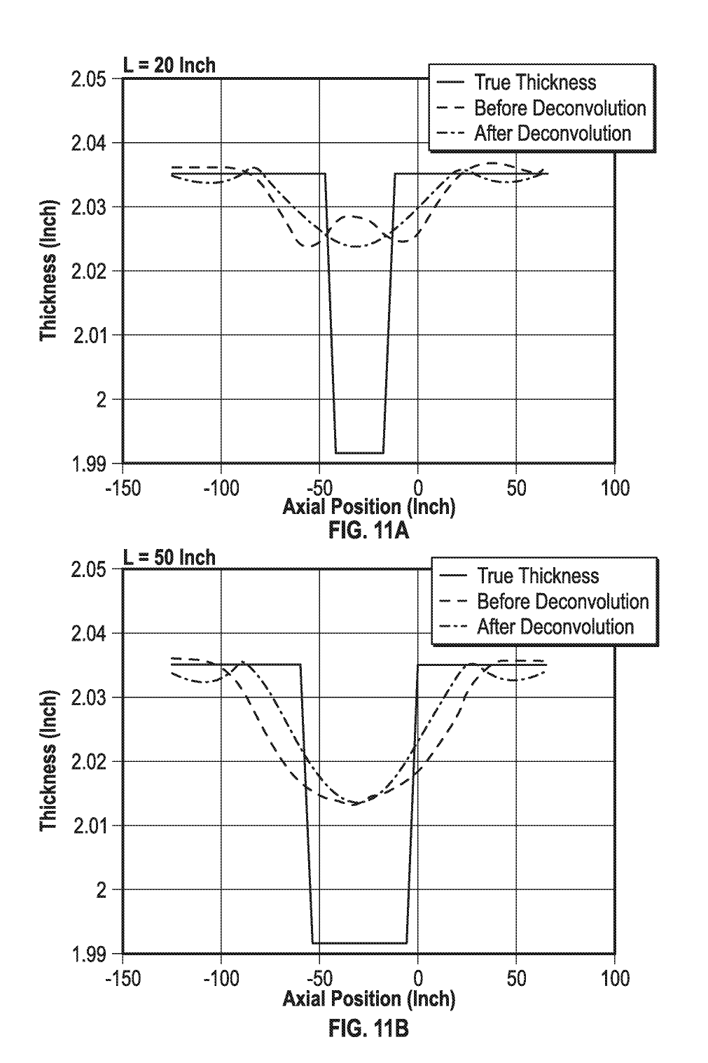

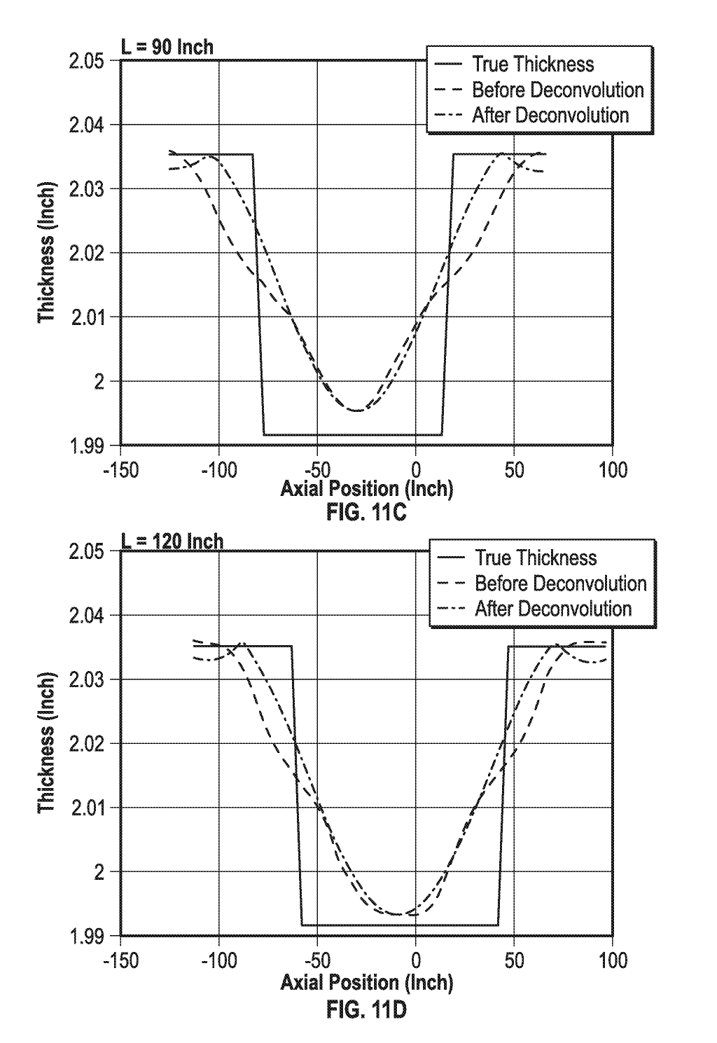

Using any of the methods described so far, the estimated restored total thickness is generally subject to an error in magnitude that increases with decreasing length of the defect. This is illustrated in FIGS. 11A-11B, which show total-thickness variations for the pipe configuration of FIG. 6 and defects on the fifth pipe corresponding to a relative thickness change of D=10% and having lengths of L=20 inches, 50 inches, 90 inches, and 120 inches, respectively. The true total-thickness variation is shown in addition to the initial estimated total-thickness variation before and the restored total-thickness variation after deconvolution with the impulse response, which is computed based on a 10 inches long defect. The restored total-thickness variations are obtained by combining deconvolution across defect locations on the various pipes. For the shortest defect, the estimated total-thickness variation relative to the nominal thickness is significantly smaller than the true total-thickness variation (FIG. 11A). For the longest defect, the estimate is very close to the true value (FIG. 11D).

The length-dependence of the error in magnitude of the estimated total thickness change is due to the fact that the RFEC-based inversion line is developed for defects of infinite length. The estimated total thickness change for a small defect will be, theoretically, one half of the true total thickness change since the total thickness change due to the small defect is translated as if there is a large detect with half of that thickness change that covers the regions in front of both the transmitter and the receiver. In practice, the estimated thickness change for the small defect may be even less than one half of the true value (as shown, e.g., in FIG. 11A) since the defect may not be sufficiently long to allow for the magnetic flux to fully pass the pipes in front of the transmitter or the receiver. Conversely, for a defect larger than the distance between the transmitter and the receiver, there will be a tool position during logging for which the defect overlaps with both the transmitter and the receiver (as is the case, e.g., for position z3 in FIG. 4), similar to the case for an infinite defect. In this case, the estimated total thickness change with RFEC-based inversion is a good approximation of the true value.

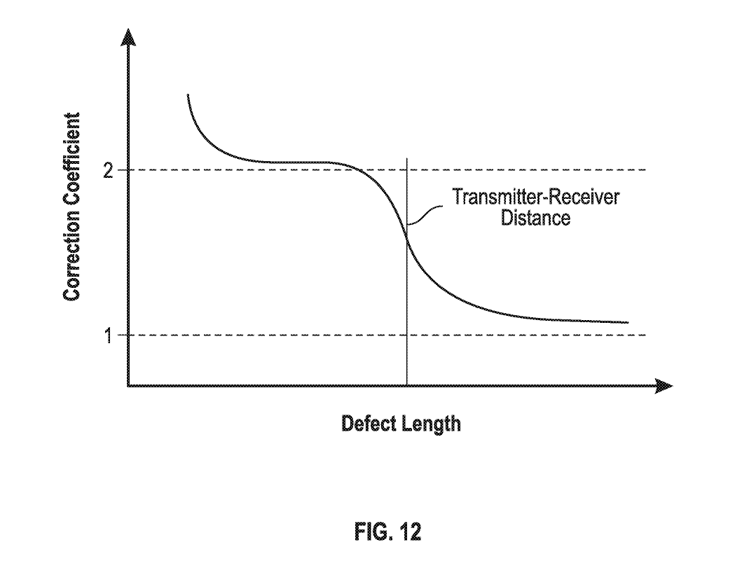

In accordance with various embodiments, the error in the total-thickness estimation is corrected for by estimating the length of the detect and then applying a proper length-dependent correction coefficient. FIG. 12 is a graph of an example level correction coefficient as a function of the length of the defect. For defects shorter than the transmitter-receiver distance, the correction coefficient is about 2 or larger; for defects longer than the transmitter-receiver distance, the correction coefficient is closer to 1. The length of the defect can be estimated, for example, by applying an edge-detection algorithm based on the gradient of the thickness variation. Suitable algorithms are well-known to those of ordinary skill in the art and include, for instance, the Canny edge-detection algorithm. To avoid resolution degradation effects such as double indication, the length estimation is implemented, in various embodiments, on the restored total-thickness variation.

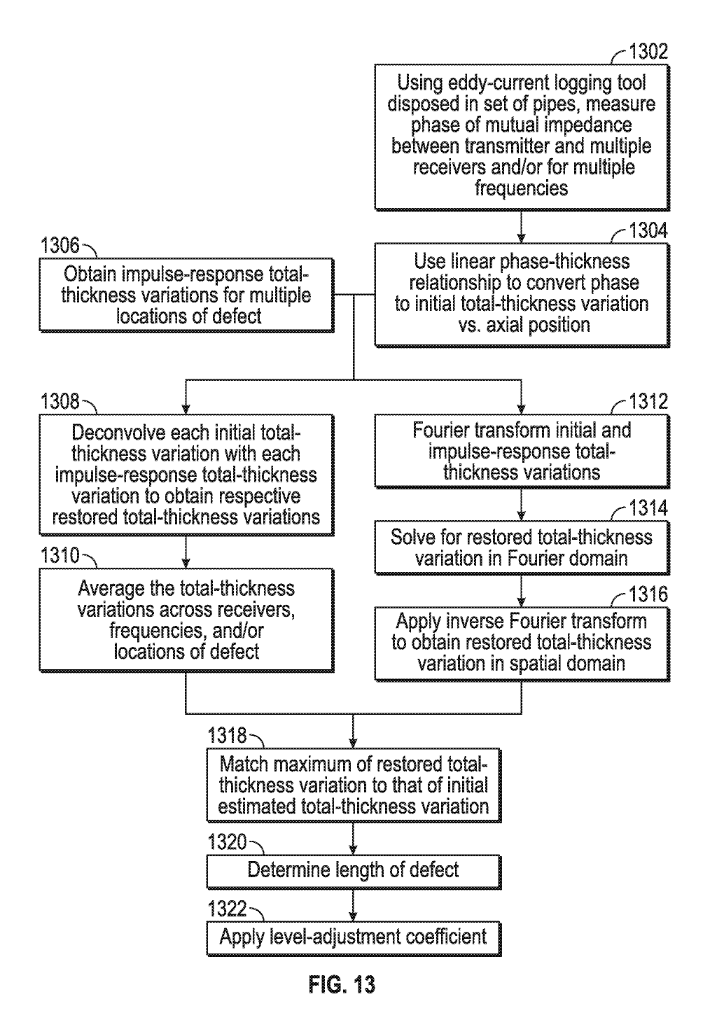

FIG. 13 is a flow chart summarizing various refinements to the basic method of determining the restored total-thickness variation, e.g., as illustrated in FIG. 5. In the illustrated method 1300, an eddy-current tool is used to measure the phase of the mutual impedance, as a function of axial position within the set of pipes, for one or more receivers and/or one or more frequencies (act 1302), and convert each measured phase variation into an initial estimated total-thickness variation for the respective receiver and frequency based on a linear phase-thickness relationship (act 1304). Further, impulse-response total-thickness variations are obtained (by simulation or measurement) for small defects located on one or more pipes (one pipe for each impulse response) (act 1306). The processing of the initial estimated total-thickness variation(s) in conjunction with the impulse-response total-thickness variation(s) then bifurcates: In one prong, each initial estimated total-thickness variation is deconvolved separately with each impulse-response total-thickness variation (act 1308), resulting in (one or more) individual restored total-thickness variations, which are then averaged, optionally with different weights applied to the different restored total-thickness variations, to yield one overall restored total-thickness variation (act 1310). In the other, alternative prong, the initial estimated total-thickness variations and the impulse-response total-thickness variations are Fourier-transformed (act 1312), and a least-squares solution for a single restored total-thickness variation is determined in the Fourier domain (act 1314) and then transformed back into the spatial domain (act 1316).

Following the restoration process, which tends to improve the shape and spatial resolution of the total-thickness variation, the level of the total-thickness variation is adjusted to reduce the error resulting from the use of a non-ideal impulse response. Level adjustment in accordance with various embodiments involves matching the maximum of the restored total-thickness variation with the maximum of the initial estimated total-thickness before restoration (act 1318). Then, a length estimation algorithm, e.g., based on an edge-detection approach, is applied to estimate the length of the defect (act 1320). Finally, a proper level adjustment coefficient (e.g., similar to the one plotted in FIG. 12) is applied to adjust the level of the restored total-thickness variation (act 1322).

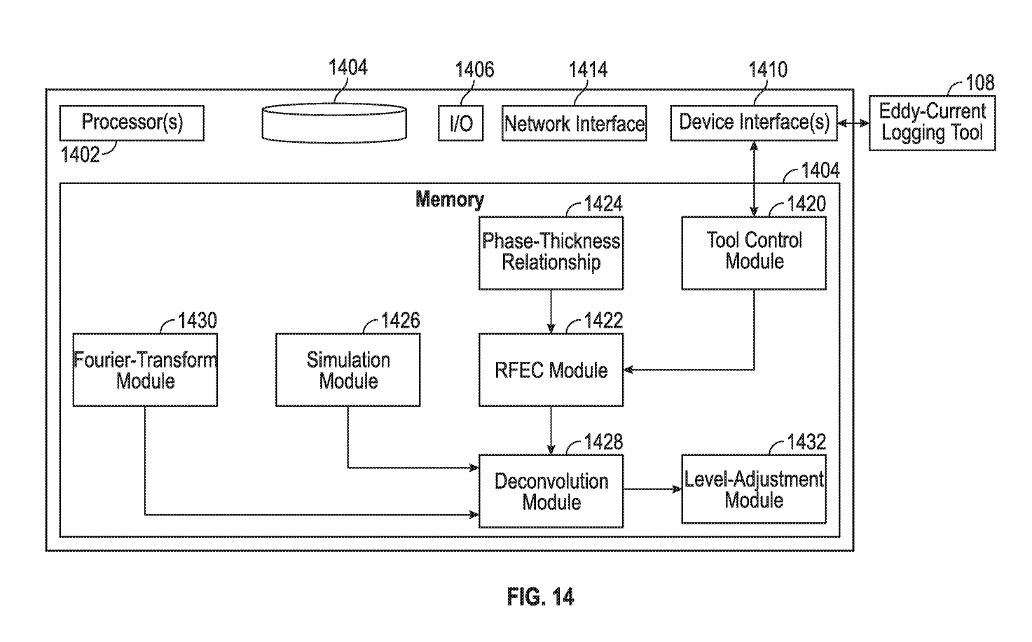

FIG. 14 is a block diagram of an example processing facility for the RFEC-based pipe thickness determination with improved resolution in accordance with various embodiments. The processing facility 1400 may be implemented, e.g., in a surface logging facility 116 or a computer communicating with the surface logging facility, or in processing circuitry 124 integrated into the electromagnetic logging tool 108. The processing facility 1400 includes one or more processors 1402 (e.g., a conventional central processing unit (CPU), graphical processing unit, or other) configured to execute software programs stored in memory 1404 (which may be, e.g., random-access memory (RAM), read-only memory (ROM), flash memory, etc.). In some embodiments, the processing facility 1400 further includes user input/output devices 1406 (e.g., a screen, keyboard, mouse, etc.), permanent data-storage devices 708 (including, e.g., solid-state, optical, and/or magnetic machine-readable media such as hard disks, CD-ROMs, DVD-ROMs, etc.), device interfaces 1410 for communicating directly or indirectly with the eddy-current logging tool 108, a network interface 1414 that facilitates communication with other computer systems and/or data repositories, and a system bus (not shown) through which the other components of the processing facility 1400 communicate. The processing facility 1400 may, for example, be a general-purpose computer that has suitable software for implementing the computational methods described herein installed thereon. While shown as a single unit, the processing facility 1400 may also be distributed over multiple machines connected to each other via a wired or wireless network such as a local network or the Internet.

The software programs stored in the memory 1404 include processor-executable instructions for performing the methods described herein, and may be implemented in any of various programming languages, for example and without limitation, C, C++, Object C, Pascal, Basic, Fortran, Matlab, and Python. The instructions may be grouped into various functional modules. In accordance with the depicted embodiment, the modules include, for instance, a tool-control module 1420 for obtaining mutual-impedance measurements from the eddy-current logging tool 108; an RFEC module 1422 for computing the initial estimated total-thickness variation from the measured phase of the mutual impedance based on a stored phase-thickness relationship 1424 for a given pipe configuration, a simulation module 1426 for computing the impulse response for a given pipe configuration and location of the small defect, a deconvolution module 1428 for computing the restored total-thickness variation in accordance with any of the embodiments described herein, a Fourier-transform module 1430 as may be used by the deconvolution module 1428, and a level-adjustment module 1432 for implementing the level-adjustment process of FIG. 13 (acts 1318-1322). Of course, the computational functionality described herein can be grouped and organized in many different ways, the depicted grouping being just one example. Further, the various computational modules depicted in FIG. 14 need not all be part of the same software program or even stored on the same machine. Rather, certain groups of modules can operate independently of the others and provide data output that can be stored and subsequently provided as input to other modules. Further, as will be readily appreciated by those of ordinary skill in the art, software programs implementing the methods described herein (e.g., organized into functional modules as depicted in FIG. 14) may be stored, separately from any processing facility, in one or more non-volatile machine-readable media (such as, without limitation, solid-state, optical, or magnetic storage media), from which they may be loaded into (volatile) system memory of a processing facility for execution.

In general, the processing facility carrying out the computational functionality described herein (optionally as organized into various functional modules) can be implemented with any suitable combination of hardware, firmware, and/or software. For example, the processing facility may be permanently configured (e.g., with hardwired circuitry) or temporarily configured (e.g., programmed), or both in part; to implement the described functionality. A tangible entity configured, whether permanently and/or temporarily, to operate in a certain manner or to perform certain operations described herein, is herein termed a “hardware-implemented module” or “hardware module,” and a hardware module using one or more processors is termed a “processor-implemented module.” Hardware modules may include, for example, dedicated circuitry or logic that is permanently configured to perform certain operations, such as a field-programmable gate array (FPGA), application-specific integrated circuit (ASIC), or other special-purpose processor. A hardware module may also include programmable logic or circuitry, such as a general-purpose processor, that is temporarily configured by software to perform certain operations. Considering example embodiments in which hardware modules are temporarily configured, the hardware modules collectively implementing the described functionality need not all co-exist at the same time, but may be configured or instantiated at different times. For example, Where a hardware module comprises a general-purpose processor configured by software to implement a special-purpose module, the general-purpose processor may be configured for respectively different special-purpose modules at different times.

Described herein have been various approaches to RFEC-based pipe-thickness determination involving deconvolution with an impulse response for a small defect. Various embodiments may feature any one or more of the following advantages: Better resolution may be achieved along the axial direction. For small defects, the double-indication effect may be eliminated, and a single defective region be measured instead. For large defects, the shape of the estimated total-thickness variation along the axial direction may be improved. This resolution enhancement is achieved entirely through processing, obviating the need for resolution-enhancing tool configurations and/or other hardware. Further, the use of multiple receivers at various distances from the transmitter (which are rendered coherent by the methods described herein) and data acquisition at multiple frequencies can improve the quality of the RFEC inversion results, and enable, in particular, pipe-thickness determinations for sets of three or more pipes. Restoring the total-thickness variation renders the vertical resolution largely independent of the transmitter/receiver distance, allowing for the high-resolution inspection of outer pipes (e.g., the fourth pipe and beyond). In addition, level correction for the total-thickness variation based on the estimated length of a detect may provide for more accurate results, in particular, for small defects. The characterization of the total thickness of multiple pipes with better resolution and accuracy provides a more precise evaluation of these components, and can ultimately lead to a significant positive impact on the production process.

The following numbered examples are illustrative embodiments. 1. A method comprising: using an eddy-current logging tool disposed interior to a set of one or more pipes having a defect in total thickness, measuring a phase of a mutual impedance between a transmitter and a receiver of the tool as a function of axial position for an axial range encompassing the defect; computing an initial estimated total-thickness variation of the one or more pipes across the axial range based on the measured phase; using deconvolution, computing a restored total-thickness variation of the one or more pipes across the axial range based on the initial estimated thickness variation and an impulse-response total-thickness variation corresponding to a small defect on the set of one or more pipes.

2. The method of example 1, further comprising obtaining the impulse-response total-thickness variation by simulation or measurement.

3. The method of example 1 or example 2, further comprising: estimating a length of the defect in total thickness of the set of one or more pipes using edge detection applied to the restored total-thickness variation; and applying a level correction coefficient depending on the estimated length to the restored thickness variation.

4. The method of example 3, further comprising, prior to estimating the length of the defect, adjusting a level of the restored total-thickness variation to match its maximum to a maximum of the initial estimated total-thickness variation.

5. The method of any one of the preceding examples, wherein multiple impulse-response total-thickness variations are obtained for multiple respective selections of the pipe on which the small defect is located, and wherein computing the restored total-thickness variation comprises averaging multiple individual restored thickness variations computed by deconvolving the initial estimated total-thickness variation separately with each of the multiple impulse-response total-thickness variations.

6. The method of any one of the preceding examples, wherein the phase of the mutual impedance is measured for at least one of multiple frequencies or multiple receivers, and multiple initial estimated total-thickness variations are computed based thereon, wherein multiple impulse-response total-thickness variations are computed for the multiple frequencies or multiple receivers, and wherein computing the restored total-thickness variation comprises averaging multiple individual restored thickness variations computed by deconvolving the multiple initial estimated total-thickness variations with the respective multiple impulse-response total-thickness variations.

7. The method of any one of the preceding examples, wherein the phase of the mutual impedance is measured for at least one of multiple frequencies or multiple receivers, and multiple initial estimated total-thickness variations are computed based thereon, wherein multiple impulse-response total-thickness variations are computed for the multiple frequencies or multiple receivers and further for multiple respective selections of the pipe on which the small defect is located, and wherein computing the restored total-thickness variation comprises averaging multiple individual restored total-thickness variations computed by deconvolving each of the multiple initial estimated total-thickness variations separately with each of the impulse-response total-thickness variations simulated for the respective frequency and receiver.

8. The method of any one of examples 1-4, wherein multiple impulse-response total thickness variations are simulated for multiple respective selections of the pipe on which the small defect is located, and wherein computing the restored total-thickness variation comprises: Fourier-transforming the initial estimated total-thickness variation and the multiple impulse-response total-thickness variations, computing a Fourier-domain restored total-thickness variation that minimizes a difference metric between the Fourier-transformed initial estimated total-thickness variation and products of the Fourier-domain restored total-thickness variation with each of the multiple Fourier-transformed impulse-response total-thickness variations, and applying an inverse Fourier transform to the Fourier-domain restored total-thickness variation to compute the restored total-thickness variation as a function of the axial position.

9. The method of any one of examples 104 and 8, wherein the phase of the impedance is measured for at least one of multiple frequencies or multiple receivers and multiple initial estimated total-thickness variations are computed based thereon, wherein multiple impulse-response total-thickness variations corresponding to respective ones of the multiple frequencies or multiple receivers are computed, and wherein computing the restored total-thickness variation comprises: Fourier-transforming the multiple initial estimated total-thickness variations and the multiple impulse-response total-thickness variations, computing a Fourier-domain restored total-thickness variation that minimizes a difference metric between the multiple Fourier-transformed initial estimated total-thickness variations and the respective products of the multiple Fourier-transformed impulse-response total-thickness variations with the Fourier-domain restored total-thickness variation, and applying an inverse Fourier transform to the Fourier-domain restored total-thickness variation to compute the restored total-thickness variation as a function of the axial position.

10. The method of any one of examples 1-4 and 8-9, wherein the phase of the impedance is measured for at least one of multiple frequencies or multiple receivers and multiple initial estimated total-thickness variations are computed based thereon, wherein multiple impulse-response total-thickness variations are computed for the multiple frequencies or multiple receivers and further for multiple respective selections of the pipe on which the small defect is located, and wherein computing the restored total-thickness variation comprises: Fourier-transforming the multiple initial estimated total-thickness variations and the multiple impulse-response total-thickness variations, computing a Fourier-domain restored total-thickness variation that minimizes a difference metric between the multiple Fourier-transformed initial estimated total-thickness variations and respective products of the Fourier-domain restored total-thickness variation with each of the multiple Fourier-transformed impulse-response total-thickness variations simulated for the respective frequency and receiver, and applying an inverse Fourier transform to the Fourier-domain restored total-thickness variation to compute the restored total-thickness variation as a function of the axial position.

11. The method of any one of examples 1-10, wherein the initial estimated total-thickness variation is computed based further on a linear phase-thickness relationship.

12. A system comprising: an eddy-current logging tool for disposal interior to a set of one or more pipes having a defect in total thickness, configured to measure a phase of a mutual impedance between a transmitter and a receiver of the tool as a function of axial position for an axial range encompassing the defect; and a processing facility configured to: compute an initial estimated total-thickness variation of the one or more pipes across the axial range based on the measured phase; and using deconvolution, compute a restored total-thickness variation of the one or more pipes across the axial range based on the initial estimated thickness variation and an impulse-response total-thickness variation corresponding to a small defect on the set of one or more pipes.

13. The system of example 12, wherein the processing facility is further configured to: estimate a length of the defect in total thickness of the set of one or more pipes using edge detection applied to the restored total-thickness variation; and apply a level correction coefficient depending on the estimated length to the restored thickness variation.

14. The system of example 12 or example 13, wherein the processing facility is configured to: compute the restored total-thickness variation as an average of multiple individual restored total-thickness variations computed by deconvolving the initial estimated total-thickness variation separately with each of multiple impulse-response total-thickness variations corresponding to multiple respective selections of the pipe on which the detect is located.

15. The system of any one of examples 12-14, wherein the eddy-current logging tool comprises multiple receivers and is configured to measure multiple respective phases of the mutual impedance between the transmitter and the respective receiver, and wherein the processing facility is configured to compute multiple initial estimated total-thickness variations from the phases measured for the multiple receivers, and to compute the restored total-thickness variation as an average of multiple individual restored total-thickness variations computed by deconvolving each of the initial estimated total-thickness variations with a respective impulse-response total-thickness variation computed for the respective transceiver.

16. The system of any one of examples claim 12-15, wherein the eddy-current logging tool is configured to measure the phase of the mutual impedance for multiple frequencies, and wherein the processing facility is configured to compute multiple initial estimated total-thickness variations from the phases measured for the multiple frequencies, and to compute the restored total-thickness variation as an average of multiple individual restored total-thickness variations computed by deconvolving each of the initial estimated total-thickness variations with a respective impulse-response total-thickness variation computed for the respective frequency.

17. The system of any one of example 12 or example 13, wherein the processing facility is configured to compute the restored total-thickness variation by Fourier-transforming the initial estimated total-thickness variation and multiple impulse-response total-thickness variations simulated for multiple respective selections of the pipe on which the small defect is located, computing a Fourier-domain restored total-thickness variation that minimizes a difference metric between the Fourier-transformed initial estimated total-thickness variation and products of the Fourier-domain restored total-thickness variation with each of the multiple Fourier-transformed impulse-response total-thickness variations, and applying an inverse Fourier transform to the Fourier-domain restored total-thickness variation to compute the restored total-thickness variation as a function of the axial position.

18. The system of any one of examples 12, 13, or 17, wherein the eddy-current logging tool comprises multiple receivers and is configured to measure multiple respective phases of the mutual impedance between the transmitter and the respective receiver, and wherein the processing facility is configured to compute multiple initial estimated total-thickness variations from the phases measured for the multiple receivers, and to compute the restored total-thickness variation by Fourier-transforming the multiple initial estimated total-thickness variations and multiple impulse-response total-thickness variations simulated for the multiple receivers, computing a Fourier-domain restored total-thickness variation that minimizes a difference metric between the multiple Fourier-transformed initial estimated total-thickness variations and the respective products of the multiple Fourier-transformed impulse-response total-thickness variations with the Fourier-domain restored total-thickness variation, and applying an inverse Fourier transform to the Fourier-domain restored total-thickness variation to compute the restored total-thickness variation as a function of the axial position.

19. The system of any one of examples 12, 13, 17, or 18, wherein the eddy-current logging tool is configured to measure the phase of the mutual impedance for multiple frequencies, and wherein the processing facility is configured to compute multiple initial estimated total-thickness variations from the phases measured for the multiple frequencies, and to compute the restored total-thickness variation by Fourier-transforming the multiple initial estimated total-thickness variations and multiple impulse-response total-thickness variations simulated for the multiple frequencies, computing a Fourier-domain restored total-thickness variation that minimizes a difference metric between the multiple Fourier-transformed initial estimated total-thickness variations and the respective products of the multiple Fourier-transformed impulse-response total-thickness variations with the Fourier-domain restored total-thickness variation, and applying an inverse Fourier transform to the Fourier-domain restored total-thickness variation to compute the restored total-thickness variation as a function of the axial position.

20. A tangible computer-readable medium storing instructions for processing a phase of a mutual impedance between a transmitter and a receiver of an eddy-current logging tool disposed interior to a set of one or more pipes having a defect in total thickness, the phase of the mutual impedance measured as a function of axial position for an axial range encompassing the defect, the instructions, when executed by one or more computers, causing the one or more computers to: compute an initial estimated total-thickness variation of the one or more pipes across the axial range based on the measured phase; and use deconvolution, compute a restored total-thickness variation of the one or more pipes across the axial range based on the initial estimated thickness variation and an impulse-response total-thickness variation corresponding to a small defect on the set of one or more pipes.

21. The computer-readable medium of claim 20, wherein the instructions implement the method of any one of examples 1-11.

22. A method comprising: using an eddy-current logging tool disposed interior to a set of one or more pipes having a defect in total thickness, measuring a phase of a mutual impedance between a transmitter and a receiver of the tool as a function of axial position for an axial range encompassing the defect; using deconvolution, computing a restored phase across the axial range based on the measured phase and an impulse-response phase corresponding to a small defect on the set of one or more pipes; and computing a restored total-thickness variation of the one or more pipes across the axial range based on the restored phase.

Many variations may be made in the systems, tools, and methods described and illustrated herein without departing from the scope of the inventive subject matter. Accordingly, the specific embodiments and examples described are intended to be illustrative; and not limiting.

What is claimed is:

1. A method comprising:
using an eddy-current logging tool disposed interior to a set of one or more pipes having a defect in total thickness, measuring a phase of a mutual impedance between a transmitter and a receiver of the tool as a function of axial position for an axial range encompassing the defect;
computing an initial estimated total-thickness variation of the one or more pipes across the axial range based on the measured phase; and
using deconvolution, computing a restored total-thickness variation of the one or more pipes across the axial range based on the initial estimated thickness variation and an impulse-response total-thickness variation corresponding to a small defect on the set of one or more pipes.

2. The method of claim 1, further comprising obtaining the impulse-response total-thickness variation by simulation or measurement.

3. The method of claim 1, further comprising:
estimating a length of the defect in total thickness of the set of one or more pipes using edge detection applied to the restored total-thickness variation; and
applying a level correction coefficient depending on the estimated length to the restored thickness variation.

4. The method of claim 3, further comprising, prior to estimating the length of the defect, adjusting a level of the restored total-thickness variation to match its maximum to a maximum of the initial estimated total-thickness variation.

5. The method of claim 1, wherein multiple impulse-response total-thickness variations are obtained for multiple respective selections of the pipe on which the small defect is located, and wherein computing the restored total-thickness variation comprises averaging multiple individual restored thickness variations computed by deconvolving the initial estimated total-thickness variation separately with each of the multiple impulse-response total-thickness variations.

6. The method of claim 1, wherein the phase of the mutual impedance is measured for at least one of multiple frequencies or multiple receivers, and multiple initial estimated total-thickness variations are computed based thereon, wherein multiple impulse-response total-thickness variations are computed for the multiple frequencies or multiple receivers, and wherein computing the restored total-thickness variation comprises averaging multiple individual restored thickness variations computed by deconvolving the multiple initial estimated total-thickness variations with the respective multiple impulse-response total-thickness variations.

7. The method of claim 1, wherein the phase of the mutual impedance is measured for at least one of multiple frequencies or multiple receivers, and multiple initial estimated total-thickness variations are computed based thereon, wherein multiple impulse-response total-thickness variations are computed for the multiple frequencies or multiple receivers and further for multiple respective selections of the pipe on which the small defect is located, and wherein computing the restored total-thickness variation comprises averaging multiple individual restored total-thickness variations computed by deconvolving each of the multiple initial estimated total-thickness variations separately with each of the impulse-response total-thickness variations simulated for the respective frequency and receiver.

8. The method of claim 1, wherein multiple impulse-response total thickness variations are simulated for multiple respective selections of the pipe on which the small defect is located, and wherein computing the restored total-thickness variation comprises:
Fourier-transforming the initial estimated total-thickness variation and the multiple impulse-response total-thickness variations,
computing a Fourier-domain restored total-thickness variation that minimizes a difference metric between the Fourier-transformed initial estimated total-thickness variation and products of the Fourier-domain restored total-thickness variation with each of the multiple Fourier-transformed impulse-response total-thickness variations, and
applying an inverse Fourier transform to the Fourier-domain restored total-thickness variation to compute the restored total-thickness variation as a function of the axial position.

9. The method of claim 1, wherein the phase of the impedance is measured for at least one of multiple frequencies or multiple receivers and multiple initial estimated total-thickness variations are computed based thereon, wherein multiple impulse-response total-thickness variations corresponding to respective ones of the multiple frequencies or multiple receivers are computed, and wherein computing the restored total-thickness variation comprises:
Fourier-transforming the multiple initial estimated total-thickness variations and the multiple impulse-response total-thickness variations,
computing a Fourier-domain restored total-thickness variation that minimizes a difference metric between the multiple Fourier-transformed initial estimated total-thickness variations and the respective products of the multiple Fourier-transformed impulse-response total-thickness variations with the Fourier-domain restored total-thickness variation, and
applying an inverse Fourier transform to the Fourier-domain restored total-thickness variation to compute the restored total-thickness variation as a function of the axial position.

10. The method of claim 1, wherein the phase of the impedance is measured for at least one of multiple frequencies or multiple receivers and multiple initial estimated total-thickness variations are computed based thereon, wherein multiple impulse-response total-thickness variations are computed for the multiple frequencies or multiple receivers and further for multiple respective selections of the pipe on which the small defect is located, and wherein computing the restored total-thickness variation comprises:
Fourier-transforming the multiple initial estimated total-thickness variations and the multiple impulse-response total-thickness variations,
computing a Fourier-domain restored total-thickness variation that minimizes a difference metric between the multiple Fourier-transformed initial estimated total-thickness variations and respective products of the Fourier-domain restored total-thickness variation with each of the multiple Fourier-transformed impulse-response total-thickness variations simulated for the respective frequency and receiver, and
applying an inverse Fourier transform to the Fourier-domain restored total-thickness variation to compute the restored total-thickness variation as a function of the axial position.

11. The method of claim 1, wherein the initial estimated total-thickness variation is computed based further on a linear phase-thickness relationship.

12. A system comprising:
an eddy-current logging tool for disposal interior to a set of one or more pipes having a defect in total thickness, configured to measure a phase of a mutual impedance between a transmitter and a receiver of the tool as a function of axial position for an axial range encompassing the detect; and
a processing facility configured to:
compute an initial estimated total-thickness variation of the one or more pipes across the axial range based on the measured phase; and
using deconvolution, compute a restored total-thickness variation of the one or more pipes across the axial range based on the initial estimated thickness variation and an impulse-response total-thickness variation corresponding to a small defect on the set of one or more pipes.

13. The system of claim 12, wherein the processing facility is further configured to:
estimate a length of the defect in total thickness of the set of one or more pipes using edge detection applied to the restored total-thickness variation; and
apply a level correction coefficient depending on the estimated length to the restored thickness variation.

14. The system of claim 12, wherein the processing facility is configured to:
compute the restored total-thickness variation as an average of multiple individual restored total-thickness variations computed by deconvolving the initial estimated total-thickness variation separately with each of multiple impulse-response total-thickness variations corresponding to multiple respective selections of the pipe on which the defect is located.

15. The system of claim 12,
wherein the eddy-current logging tool comprises multiple receivers and is configured to measure multiple respective phases of the mutual impedance between the transmitter and the respective receiver, and
wherein the processing facility is configured to compute multiple initial estimated total-thickness variations from the phases measured for the multiple receivers, and to compute the restored total-thickness variation as an average of multiple individual restored total-thickness variations computed by deconvolving each of the initial estimated total-thickness variations with a respective impulse-response total-thickness variation computed for the respective transceiver.

16. The system of claim 12,
wherein the eddy-current logging tool is configured to measure the phase of the mutual impedance for multiple frequencies, and
wherein the processing facility is configured to compute multiple initial estimated total-thickness variations from the phases measured for the multiple frequencies, and to compute the restored total-thickness variation as an average of multiple individual restored total-thickness variations computed by deconvolving each of the initial estimated total-thickness variations with a respective impulse-response total-thickness variation computed for the respective frequency.

17. The system of claim 12, wherein the processing facility is configured to compute the restored total-thickness variation by
Fourier-transforming the initial estimated total-thickness variation and multiple impulse-response total-thickness variations simulated for multiple respective selections of the pipe on which the small defect is located,
computing a Fourier-domain restored total-thickness variation that minimizes a difference metric between the Fourier-transformed initial estimated total-thickness variation and products of the Fourier-domain restored total-thickness variation with each of the multiple Fourier-transformed impulse-response total-thickness variations, and
applying an inverse Fourier transform to the Fourier-domain restored total-thickness variation to compute the restored total-thickness variation as a function of the axial position.

18. The system of claim 12,
wherein the eddy-current logging tool comprises multiple receivers and is configured to measure multiple respective phases of the mutual impedance between the transmitter and the respective receiver, and
wherein the processing facility is configured to compute multiple initial estimated total-thickness variations from the phases measured for the multiple receivers, and to compute the restored total-thickness variation by Fourier-transforming the multiple initial estimated total-thickness variations and multiple impulse-response total-thickness variations simulated for the multiple receivers, computing a Fourier-domain restored total-thickness variation that minimizes a difference metric between the multiple Fourier-transformed initial estimated total-thickness variations and the respective products of the multiple Fourier-transformed impulse-response total-thickness variations with the Fourier-domain restored total-thickness variation, and applying an inverse Fourier transform to the Fourier-domain restored total-thickness variation to compute the restored total-thickness variation as a function of the axial position.

19. The system of claim 12,
wherein the eddy-current logging tool is configured to measure the phase of the mutual impedance for multiple frequencies, and
wherein the processing facility is configured to compute multiple initial estimated total-thickness variations from the phases measured for the multiple frequencies, and to compute the restored total-thickness variation by Fourier-transforming the multiple initial estimated total-thickness variations and multiple impulse-response total-thickness variations simulated for the multiple frequencies, computing a Fourier-domain restored total-thickness variation that minimizes a difference metric between the multiple Fourier-transformed initial estimated total-thickness variations and the respective products of the multiple Fourier-transformed impulse-response total-thickness variations with the Fourier-domain restored total-thickness variation, and applying an inverse Fourier transform to the Fourier-domain restored total-thickness variation to compute the restored total-thickness variation as a function of the axial position.

20. A tangible computer-readable medium storing instructions for processing a phase of a mutual impedance between a transmitter and a receiver of an eddy-current logging tool disposed interior to a set of one or more pipes having a defect in total thickness, the phase of the mutual impedance measured as a function of axial position for an axial range encompassing the defect, the instructions, when executed by one or more computers, causing the one or more computers to:
compute an initial estimated total-thickness variation of the one or more pipes across the axial range based on the measured phase; and
use deconvolution, compute a restored total-thickness variation of the one or more pipes across the axial range based on the initial estimated thickness variation and an impulse-response total-thickness variation corresponding to a small defect on the set of one or more pipes.
